(19) United States
(12) Patent Application Publication
(10) Pub. No.: US 2021/0297594 A1
(43) Pub. Date: Sep. 23, 2021

(54) IMAGING CONTROL APPARATUS, IMAGING CONTROL METHOD, AND PROGRAM

(71) Applicant: SONY CORPORATION, TOKYO (JP)

(72) Inventor: SHINNOSUKE USAMI, TOKYO (JP)

(21) Appl. No.: 17/250,495

(22) PCT Filed: May 23, 2019
(86) PCT No.: PCT/JP2019/020426

§ 371 Date: Jan. 28, 2021

(30) Foreign Application Priority Data
Aug. 6, 2018 (JP) 2018-147955

(51) Int. Cl. H04N 5/232; H04N 5/247

(52) U.S. Cl. CPC H04N 5/23254; H04N 5/247; H04N 5/23287

(57) ABSTRACT

In subject tracking control in a case where an imaging apparatus having a hand shake correction function is used, it is possible to prevent deterioration of tracking response. Hand shake correction of an imaging apparatus is controlled on the basis of an obtained movement control amount of the imaging apparatus to make a position of a subject a predetermined position in a captured image. Therefore, the hand shake correction control is performed on the basis of a movement amount of the imaging apparatus to track the subject.

### TECHNICAL FIELD

The present technology relates to an imaging control apparatus, an imaging control method, and a program, and more particularly, to a control technology for hand shake correction in a case where subject tracking is performed.

### BACKGROUND ART

For example, a platform apparatus capable of driving an imaging apparatus to change an imaging direction or an imaging viewpoint, such as an electric gimbal or the like, is known. Then, it is possible to perform subject tracking using this kind of the platform apparatus. Specifically, drive control of the platform apparatus (drive control of an actuator built in the platform apparatus) is performed to make a subject to be targeted positioned at a predetermined position such as a central portion or the like in a captured image.

Note that an example of a related conventional technology can include the following Patent Document 1.

### CITATION LIST

### Patent Document

Patent Document 1: Japanese Patent Application Laid-Open No. 2015-89108

### SUMMARY OF THE INVENTION

### Problems to be Solved by the Invention

Such a platform apparatus is provided with, for example, a grip portion that can be grasped by a user, such that hand-held imaging can be performed while grasping the platform apparatus by the user. In a case where the hand-held imaging is performed, a subject tracking function by rough subject tracking and drive control of the actuator described above according to a change of a direction of the platform apparatus by a user plays an auxiliary role in such a subject tracking performed by a user.

Here, in the case of the hand-held imaging, it is effective to use an imaging apparatus having a hand shake correction function as an imaging apparatus in which a platform apparatus is loaded.

However, in the imaging apparatus with the hand shake correction function, in a case where the subject tracking is performed by drive control of the platform apparatus, the hand shake correction acts in a direction opposite to a drive direction of the platform for the subject tracking, and tracking response may deteriorate. For example, in a case where a user quickly changes a direction of the platform apparatus according to a movement direction of the subject in a scene where a stationary subject starts to quickly move, the hand shake correction works (acts) in a direction opposite to the movement direction of the subject, such that the tracking response to the subject is likely to significantly deteriorate.

The present technology is made in view of the above circumstances, and an object of the present technology is to prevent the deterioration of the tracking response in the subject tracking control in a case where the imaging apparatus having the hand shake correction function is used.

### Solution to Problems

According to the present technology, an imaging control apparatus includes a control unit that controls hand shake correction of an imaging apparatus on the basis of an obtained movement control amount of the imaging apparatus to make a position of a subject a predetermined position in a captured image.

With this arrangement, the hand shake correction control is performed on the basis of a movement amount of the imaging apparatus to track the subject.

In the imaging control apparatus according to the present technology, the control unit controls the hand shake correction on the basis of a result of comparing the movement control amount with a threshold value.

With this arrangement, the hand shake correction can be controlled so that the hand shake correction is maintained in a turned-on state in a case where the movement amount of the imaging apparatus is equal to or less than a predetermined amount and the hand shake correction is turned off in a case where the movement amount is larger than the predetermined amount.

In the imaging control apparatus according to the present technology, the control unit dynamically changes the threshold value.

With this arrangement, the hand shake correction effect can be adaptively changed depending on a predetermined condition.

In the imaging control apparatus according to the present technology, the control unit controls the hand shake correction on the basis of a resolution of the captured image for obtaining the movement control amount.

In a case where the movement control amount for tracking is obtained on the basis of a position of the subject detected from the captured image, a low resolution of the captured image is a noise of the movement control amount. Therefore, the hand shake correction is controlled on the basis of the resolution, such that the hand shake correction effect is prevented from being turned off unnecessarily in response to the noise.

In the imaging control apparatus according to the present technology, the control unit controls the hand shake correction on the basis of a result of comparing the movement control amount with a threshold value, and sets the threshold value to have a negative correlation with the resolution.

With this arrangement, the hand shake correction is prevented from being turned off unnecessarily in response to the noise.

In the imaging control apparatus according to the present technology, the control unit changes the threshold value depending on an imaging target scene.

With this arrangement, the hand shake correction effect can be changed depending on a change of the imaging target scene such as a scene where a subject does not move while being stationary, a scene where a stationary subject starts to quickly move, or the like.

In the imaging control apparatus according to the present technology, the control unit controls the hand shake correction on the basis of a movement direction of the subject.

With this arrangement, it is possible to reduce the hand shake correction effect for shake occurring in the movement direction of the subject and to increase the hand shake correction effect for shake occurring in a direction different from the movement direction of the subject.

In the imaging control apparatus according to the present technology, the control unit makes hand shake correction effects different in a direction corresponding to the movement direction and a direction different from the direction.

With this arrangement, it is possible to reduce the hand shake correction effect in a direction in which tracking response is more likely to deteriorate, and it is possible to increase the hand shake correction effect in a direction in which the tracking response is less likely to deteriorate.

In the imaging control apparatus according to the present technology, the control unit obtains the movement control amount on the basis of information on the position of the subject detected from the captured image.

With this arrangement, in the obtaining of the movement control amount, the position information on the subject can be detected from the captured image.

In the imaging control apparatus according to the present technology, the control unit obtains the movement control amount on the basis of an attention position of the subject detected from the captured image.

With this arrangement, tracking control can be performed by making a portion to be paid attention of the subject a predetermined position such as the central position or the like in the captured image.

In the imaging control apparatus according to the present technology, the imaging apparatus that captures the captured image for obtaining the movement control amount and the imaging apparatus whose hand shake correction is controlled by the control unit are separate apparatuses.

With this arrangement, the imaging apparatus whose hand shake correction is controlled is not required to execute processing for obtaining the movement control amount on the basis of its own captured image.

In the imaging control apparatus according to the present technology, the control unit controls the hand shake correction on the basis of the movement control amount obtained on the basis of parallax information between the two imaging apparatuses.

With this arrangement, it is possible to realize accurate subject tracking while reducing a processing load of the imaging apparatus whose hand shake correction is controlled.

In the imaging control apparatus according to the present technology, the control unit controls the hand shake correction on the basis of movement information on a head-mounted display.

With this arrangement, in a case where a movement of the head-mounted display corresponds to an instruction to switch the tracking target subject by a user, the hand shake correction acts, and thus, it is possible to prevent tracking of a new subject from being inhibited.

Furthermore, according to the present technology, an imaging control method includes controlling hand shake correction of an imaging apparatus on the basis of an obtained movement control amount of the imaging apparatus to make a position of a subject a predetermined position in a captured image.

The similar action to that of the imaging control apparatus according to the present technology described above is obtained also by such an imaging control method.

Furthermore, according to the present technology, there is provided a program for causing an information processing device to realize a function of controlling hand shake correction of an imaging apparatus on the basis of an obtained movement control amount of the imaging apparatus to make a position of a subject a predetermined position in a captured image.

The imaging control apparatus according to the present technology described above is realized by such a program.

### Effects of the Invention

According to the present technology, in the subject tracking control in a case where the imaging apparatus having the hand shake correction function is used, it is possible to prevent the deterioration of the tracking response.

Note that the effects described herein are not necessarily limited and may be any effect described in the present disclosure.

### BRIEF DESCRIPTION OF DRAWINGS

FIG. 1 is an explanatory view of an appearance configuration example of an imaging system including an imaging control apparatus as a first embodiment of the present technology.

FIG. 2 is a block diagram illustrating an internal configuration example of a platform apparatus of an embodiment.

FIG. 3 is a block diagram illustrating an internal configuration example of the imaging control apparatus of the first embodiment.

FIG. 4 is a flowchart illustrating a process for subject tracking.

FIG. 5 is a view schematically illustrating a state where information on a movement control amount for the subject tracking is input to the platform apparatus.

FIG. 6 is an explanatory view of an action by a hand shake correction control as the first embodiment.

FIG. 7 is a flowchart illustrating a specific processing procedure to be executed to realize the hand shake correction control as the first embodiment.

FIG. 8 is an explanatory view of an action by changing a threshold value of the movement control amount.

FIG. 9 is a flowchart illustrating a specific processing procedure to be executed to realize the hand shake correction control as Control Example I.

FIG. 10 is an explanatory view of an imaging target scene.

FIG. 11 is a flowchart illustrating a specific processing procedure to be executed to realize the hand shake correction control as Control Example II.

FIG. 12 is an explanatory view of a movement direction of a subject.

FIG. 13 is a flowchart illustrating a specific processing procedure to be executed to realize the hand shake correction control as Control Example III.

FIG. 14 is a view for explaining a configuration example of an imaging system as a first modification.

FIG. 15 is a block diagram illustrating an internal configuration example of an imaging apparatus that obtains a captured image for obtaining a movement control amount in the first modification.

FIG. 16 is a block diagram illustrating the internal configuration example of the imaging apparatus whose hand shake correction is controlled in the first modification.

FIG. 17 is an explanatory view of an example in which the imaging apparatus that obtains the captured image for obtaining the movement control amount is not mounted on the platform apparatus.

FIG. 18 is a view for explaining a configuration example of an imaging system as a second modification.

FIG. 19 is a block diagram illustrating an internal configuration example of an HMD.

FIG. 20 is a block diagram illustrating an internal configuration example of an imaging apparatus in the second modification.

FIG. 21 is a flowchart illustrating a specific processing procedure to be executed to realize an operation as the second modification.

FIG. 22 is a view illustrating a platform apparatus that can be driven in a roll direction.

### MODES FOR CARRYING OUT THE INVENTION

Hereinafter, embodiments will be described in the following order.
<1. First Embodiment>
[1-1. Configuration Example of Apparatus]
[1-2. Regarding Subject Tracking]
[1-3. Hand Shake Correction Control]
<2. Second Embodiment>
[2-1. Control Example I]
[2-2. Control Example II]
[2-3. Control Example III]
<3. Modification>
[3-1. First Modification]
[3-2. Second Modification]
[3-3. Other Modifications]
<4. Summary of Embodiments>
<5. Present Technology>

### 1. First Embodiment

### 1-1. Configuration Example of Apparatus

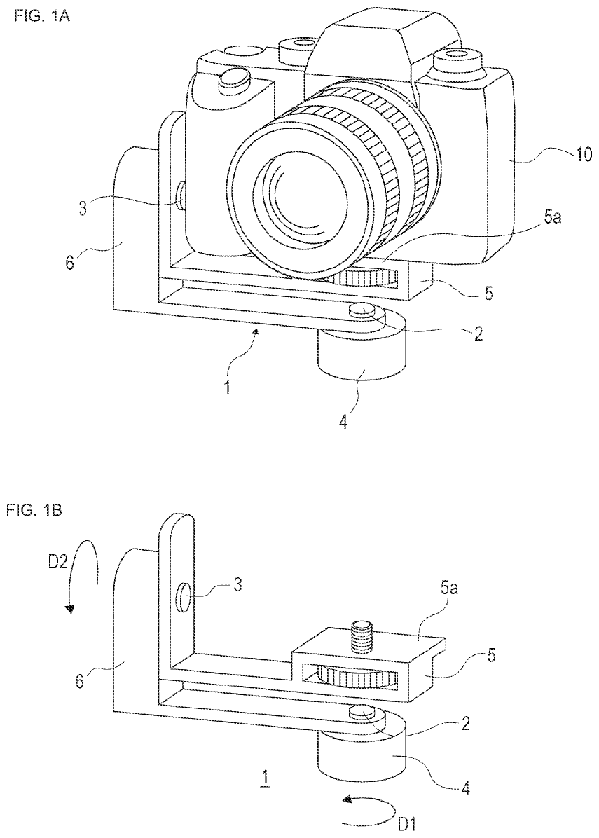

FIG. 1 is an explanatory view of an appearance configuration example of an imaging system including an imaging control apparatus (imaging apparatus 10) as a first embodiment of the present technology.

The imaging system includes the imaging apparatus 10 and a platform apparatus 1. In the imaging system, an imaging direction of the imaging apparatus 10 is changed by a rotation operation of the platform apparatus 1 in a state where the imaging apparatus 10 is loaded on the platform apparatus 1. Particularly, the platform apparatus 1 includes an actuator as described later, and drive control of the actuator is performed, such that automatic tracking of a subject which is a tracking target is performed.

Note that the “imaging direction” is a direction corresponding to a direction in which the imaging apparatus 10 captures an image, and refers to a front direction (a direction indicating a subject side) in an optical axis of an imaging optical system included in the imaging apparatus 10. In the case of the system illustrated in FIG. 1, the imaging direction is changed according to a rotation angle of the platform apparatus 1, and thus, the imaging direction is uniquely determined according to the rotation angle of the platform apparatus 1.

FIG. 1A illustrates a state where the imaging apparatus 10 is loaded (mounted) on the platform apparatus 1, and FIG. 1B illustrates only the platform apparatus 1.

In the platform apparatus 1, a rotation shaft portion 2 for rotation in a Yaw direction indicated by an arrow D1 in FIG. 1B and a rotation shaft portion 3 for rotation in a Pitch direction indicated by an arrow D2 are provided, and a base portion 4, a mounting portion 5, and an arm portion 6 are also provided.

The mounting portion 5 is, for example, an L-shaped member, and a joint mechanism 5a corresponding to a mechanism (not illustrated) formed at a bottom of the imaging apparatus 10 is provided on a top surface of a bottom of the mounting portion 5. Therefore, the imaging apparatus 10 can be fixed as illustrated in FIG. 1A.

The mounting portion 5 is attached to the arm portion 6 via the rotation shaft portion 3. Therefore, the mounting portion 5 is rotatable with respect to the arm portion 6 in the Pitch direction.

The arm portion 6 is, for example, an L-shaped member, and is attached to the base portion 4 at the rotation shaft portion 2. Therefore, the arm portion 6 (and the mounting portion 5 connected to the arm portion) is rotatable in the Yaw direction.

For example, such a platform apparatus 1 is used, such that the imaging direction of the imaging apparatus 10 can be changed to the Yaw direction and the Pitch direction. Therefore, the automatic tracking of the subject can be performed.

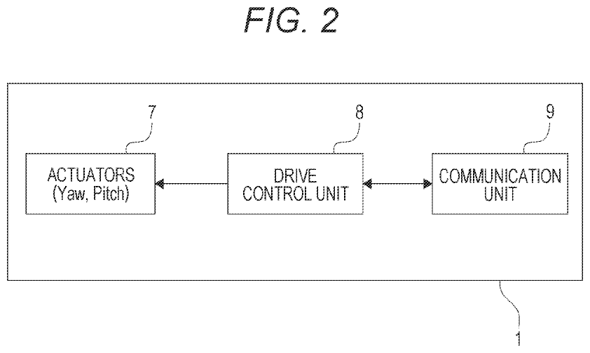

FIG. 2 is a block diagram illustrating an internal configuration example of the platform apparatus 1.

The platform apparatus 1 includes an actuator 7, a drive control unit 8, and a communication unit 9.

As the actuator 7, a Yaw direction actuator (motor) for rotationally driving the rotation shaft portion 2 and a Pitch direction actuator (motor) for rotationally driving the rotation shaft portion 3 are provided in the present example.

The drive control unit 8 includes a drive circuit of the actuator 7, a control circuit for controlling the drive circuit, or the like, and performs drive control of the actuator 7. In particular, the drive control unit 8 of the present example performs the drive control of the actuator 7 according to information input via the communication unit 9.

The communication unit 9 performs data communication with an external apparatus according to a predetermined communication format. In particular, the communication unit 9 of the present example performs data communication according to a communication format supported by a communication unit 19 included in the imaging apparatus 10 as described later.

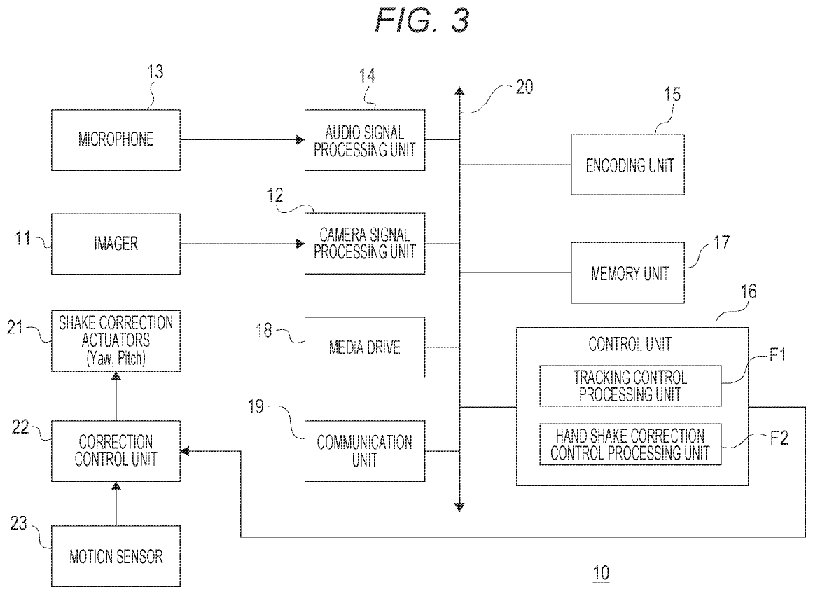

FIG. 3 is a block diagram illustrating an internal configuration example of the imaging apparatus 10.

The imaging apparatus 10 is a digital camera apparatus. The imaging apparatus 10 captures an image of a subject, and can record image data as a still image or a moving image in a recording medium, or transmit the image data to an external apparatus.

The imaging apparatus 10 as illustrated includes an imager (image sensor) 11, a camera signal processing unit 12, a microphone 13, an audio signal processing unit 14, an encoding unit 15, a control unit 16, a memory unit 17, a media drive 18, a communication unit 19, a bus 20, a shake correction actuator 21, a correction control unit 22, and a motion sensor 23. The camera signal processing unit 12, the audio signal processing unit 14, the encoding unit 15, the control unit 16, the memory unit 17, the media drive 18, and the communication unit 19 are connected to the bus 20, and the respective units can perform data communication with each other via the bus 20.

The imager 11 is, for example, an imaging sensor such as a charge coupled device (CCD) sensor, a complementary metal oxide semiconductor (CMOS) sensor, or the like. The imager 11 receives subject light incident through the imaging optical system (not illustrated), converts the subject light into an electric signal, and outputs the electric signal.

The imager 11 executes, for example, correlated double sampling (CDS) processing, automatic gain control (AGC) processing, and the like of the electric signal obtained by photoelectric conversion of the received light, and further performs analog/digital (A/D) conversion processing. Then, the imager 11 outputs an image signal as digital data to the camera signal processing unit 12 provided at the subsequent stage.

The camera signal processing unit 12 is, for example, an image processing processor such as a digital signal processor (DSP) or the like. The camera signal processing unit 12 performs various signal processing for a digital signal (image signal) from the imager 11. For example, the camera signal processing unit 12 performs pre-processing, synchronization processing, YC generation processing, resolution conversion processing, and the like.

After a sound collection signal from the microphone 13 is converted into a digital signal via an amplifier or an A/D converter (not illustrated), a predetermined audio signal processing is performed by the audio signal processing unit 14.

The encoding unit 15 receives the image signal and an audio signal from the camera signal processing unit 12 and the audio signal processing unit 14, respectively, and encodes the image signal and the audio signal according to a predetermined data format. As the encoding, encoding that compresses the amount of data is performed, and specifically, examples of the encoding can include compression coding such as H264, Moving Picture Experts Group (MPEG)-2, or the like for an image signal as a moving image, MPEG Audio Layer-3 (MP3), advanced audio coding, or the like for an audio signal, and the like.

The image signal or the audio signal encoded by the encoding unit 15 is hereinafter referred to as “coded data”.

The control unit 16 includes a microcomputer (information processing device) including a central processing unit (CPU), a read only memory (ROM), a random access memory (RAM), and the like. The CPU executes processing in accordance with a program stored in the ROM and the like to generally control the entire imaging apparatus 10.

The RAM is a work area at the time of various data processing of the CPU, and is used to temporarily store data or programs, for example. The ROM is used to store application programs for various operations, firmware, or the like, in addition to an operating system (OS) for allowing the CPU to control each unit or content files such as image files or the like.

For example, the control unit 16 can control the coded data obtained by the encoding unit 15 to be recorded in the recording medium mounted in the media drive 18, or can control the communication unit 19 to transmit the coded data to the external apparatus.

Furthermore, in particular, the control unit 16 in the present example has a function as a tracking control processing unit F1 and a hand shake correction control processing unit F2, and these functions will be described later.

The memory unit 17 includes, for example, a non-volatile memory, and is used to store various data. In particular, the memory unit 17 is used to store data used in various processing performed by the control unit 16.

The media drive 18 is configured to be detachably attachable to a portable recording medium, and is configured as a reader/writer unit that reads and writes data to and from the mounted recording medium. Examples of the recording medium to which the media drive 18 is detachably attachable can include a memory card (for example, a portable flash memory) that can be detachably attachable to the imaging apparatus 10 and the like.

The communication unit 19 performs data communication with an external apparatus according to a predetermined communication format. In particular, the communication unit 19 of the present example can perform data communication with the communication unit 9 in the platform apparatus 1.

Here, the data communication between the communication unit 9 in the platform apparatus 1 and the communication unit 19 may be, for example, wire communication such as universal serial bus (USB) or the like, or wireless communication such as Bluetooth (registered trademark) or the like.

The shake correction actuator 21, the correction control unit 22, and the motion sensor 23 are provided to realize an optical hand shake correction function.

The motion sensor 23 is a sensor that detects a movement in a predetermined direction of the imaging apparatus 10. In the present example, an angular velocity sensor (biaxial angular velocity sensor) for detecting a movement in a rotation direction of each of the Yaw direction and the Pitch direction.

The shake correction actuator 21 is an actuator for driving a shake correction lens provided in the imaging optical system of the imaging apparatus 10.

The correction control unit 22 calculates a deviation between the imager 11 and an optical axis on the basis of movement information (angular velocities in the Yaw direction and the Pitch direction in the present example) detected by the motion sensor 23, calculates a movement amount of the shake correction lens required in a direction to cancel the deviation, and generates a drive signal for the shake correction actuator 21 according to the movement amount.

The shake correction actuator 21 is driven on the basis of the drive signal, such that the shake correction lens is displaced to cancel the deviation between the imager 11 and the optical axis, and thus, shake correction is realized.

Note that, in the optical hand shake correction, a method of displacing the imager 11 can be adopted instead of a method of displacing the shake correction lens.

### 1-2. Regarding Subject Tracking

In the imaging apparatus 10, the control unit 16 performs drive control of the platform apparatus 1 to make a position of a tracking target subject a target position in a captured image by specifying a position of a tracking target subject on the basis of a captured image obtained by an imaging operation of the imager 11, calculating an error amount between the specified position of the tracking target subject and a target position in the captured image, and outputting a movement control amount of the imaging apparatus 10 based on the calculated error amount to the platform apparatus 1, by a function as the tracking control processing unit F1.

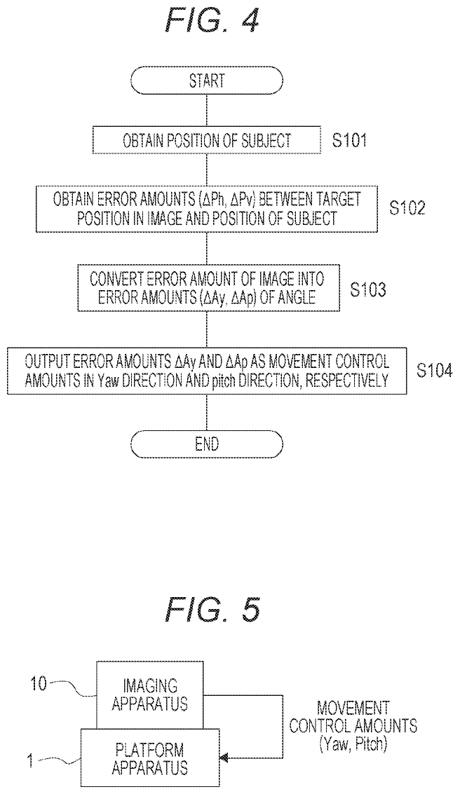

FIG. 4 is a flowchart illustrating a process for subject tracking executed by the control unit 16.

Note that the process illustrated in FIG. 4 is repeatedly executed for each frame of the captured image.

First, the control unit 16 obtains a position of a subject in step S101. That is, a position of the tracking target subject in the captured image is specified. As processing in step S101, the control unit 16 performs image analysis to specify the tracking target subject on the basis of the image signal processed (or in a processing process) by the camera signal processing unit 12, and also specifies a position of the specified tracking target subject in the captured image.

In the present example, an attention position is specified as the position of the tracking target subject.

Here, the attention position refers to a determined position to be paid attention of the tracking target subject. If the subject is a person, examples of the attention position can include the center (center in vertical and horizontal directions) or the center of gravity of the whole body, the center of face, the center of shoulders, the center of torso, and the like. Alternatively, if the subject is a train or an automobile, examples of the attention position can include a leading end, a driver's seat position, or the like in a traveling direction thereof.

In the present example, the attention position is predetermined depending on a type of the subject, and the control unit 16 specifies an attention position of the tracking target subject depending on a type of the tracking target subject.

Note that it is conceivable that the attention position is predetermined for each type of the subject according to user operations.

In following step S102, the control unit 16 obtains an error amount between a target position in an image and a position of a subject. That is, in the present example, the control unit 16 obtains an error amount between the specified position (attention position) of the tracking target subject and the target position in the captured image as described above. Here, the target position is, for example, the center (center in horizontal and vertical directions) of the captured image. Furthermore, error amounts in both the horizontal direction and the vertical direction are obtained as the error amount. Hereinafter, as for the error amount between the position of the tracking target subject and the target position in the captured image, the error amount in the horizontal direction is referred to as an “error amount ΔPh” and the error amount in the vertical direction is referred to as an “error amount ΔPv”.

In step S103 following step S102, the control unit 16 performs processing for converting (changing) the error amount of the image into an error amount of an angle. That is, the error amounts ΔPh and ΔPv obtained in step S102 and represented by a pixel number unit are converted into error amounts in the rotation directions of the Yaw direction and the Pitch direction, respectively. The conversion can be performed on the basis of an imaging parameter (a focal distance, size information on the imager 11, or the like) of the imaging apparatus 10.

Hereinafter, the error amount obtained by changing the error amount ΔPh in the horizontal direction to an angle in the Yaw direction is referred to as an “error amount ΔAy”, and the error amount obtained by changing the error amount ΔPh in the vertical direction to an angle in the Pitch direction is referred to as an “error amount ΔAp”.

In step S104 following step S103, the control unit 16 performs processing for outputting the error amounts ΔAy and ΔAp to the platform apparatus 1 as movement control amounts in the Yaw direction and the Pitch direction. That is, the control unit 16 executes processing for transmitting the error amounts ΔAy and ΔAp to the platform apparatus 1 via the communication unit 19.

Here, the movement control amount refers to a control amount of the movement when the imaging apparatus 10 is moved in a predetermined direction for the subject tracking. The error amounts ΔAy and ΔAp correspond to a control amount to move the imaging apparatus 10 in the Yaw direction and a control amount to move the imaging apparatus 10 in the Pitch direction, respectively.

By the processing described above, the movement control amounts in both the Yaw direction and the Pitch direction are input from the imaging apparatus 10 to the platform apparatus 1 as illustrated in FIG. 5.

In the platform apparatus 1, the error amounts ΔAy and ΔAp are input to the drive control unit 8 via the communication unit 9, and the drive control unit 8 drives the actuators 7 (the Yaw direction actuator and the Pitch direction actuator) with drive amounts according to these error amounts ΔAy and ΔAp.

Therefore, tracking control is realized to make the position of the tracking target subject to coincide with the target position in the captured image.

### 1-3. Hand Shake Correction Control

Subsequently, the hand shake correction control processing unit F2 included in the control unit 16 will be described.

The control unit 16 controls the hand shake correction performed by the shake correction actuator 21, the correction control unit 22, and the motion sensor 23, on the basis of the error amounts ΔAy and ΔAp obtained by the tracking control processing unit F1, by a function as the hand shake correction control processing unit F2.

The control unit 16 of the present example controls the hand shake correction on the basis of results obtained by comparing the movement control amounts as the error amounts ΔAy and ΔAp with threshold values. Specifically, the control unit 16 turns off the hand shake correction in a case where an error amount ΔA (absolute value) exceeds a threshold value TH, and turns on the hand shake correction in a case where the error amount ΔA is equal to or less than the threshold value TH, by using a threshold value THy and a threshold value THp set with respect to the error amounts ΔAy and ΔAp, respectively.

In the present example, the hand shake correction in each of the Yaw direction and the Pitch direction is independently controlled. That is, in the Yaw direction, if ΔAy>THy, the hand shake correction in the Yaw direction is turned off, and if ΔAy THy, the hand shake correction in the Yaw direction is turned on, on the basis of the result of comparing the error amount ΔAy (absolute value) with the threshold value THy. Furthermore, in the Pitch direction, if ΔAp>THp, the hand shake correction in the Pitch direction is turned off, and if ΔAp THp, the hand shake correction in the Pitch direction is turned on, on the basis of the result of comparing the error amount ΔAp (absolute value) with the threshold value THp.

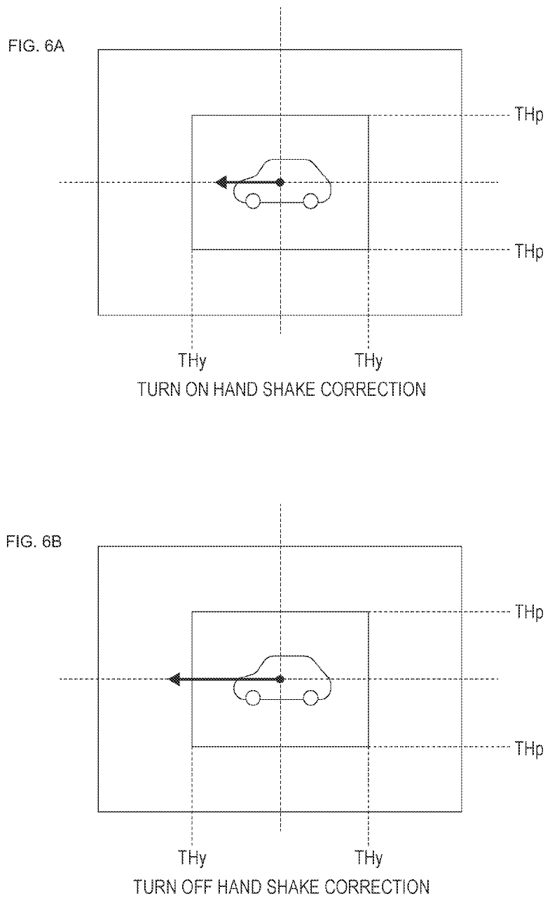

FIG. 6 is a view for explaining an action by the hand shake correction control described above. Note that in each of FIGS. 6A and 6B, an outer frame represents an image frame of the captured image, and an inner frame represents the threshold value TH for the error amount ΔA. Furthermore, each of arrows in FIGS. 6A and 6B indicates only the error amount ΔAy out of the error amounts ΔAy and ΔAp.

For example, in the Yaw direction, if the input error amount ΔAy (absolute) is equal to or less than the threshold value THy, the hand shake correction is turned on, as illustrated in FIG. 6A, and on the other hand, in a case where the input error amount ΔAy (absolute) exceeds the threshold value THy, the hand shake correction is turned off, as illustrated in FIG. 6B. Although not illustrated in FIGS. 6A and 6B, it is also similarly applied to the Yaw direction.

By such a hand shake correction control, for example, in a case where a user quickly changes a direction of the platform apparatus 10 according to a movement direction of the subject in a scene where a stationary tracking target subject starts to quickly move, the hand shake correction can be turned off, the hand shake correction can be prevented from working (acting) in a direction opposite to the movement direction of the subject, and tracking response can be prevented from deteriorating.

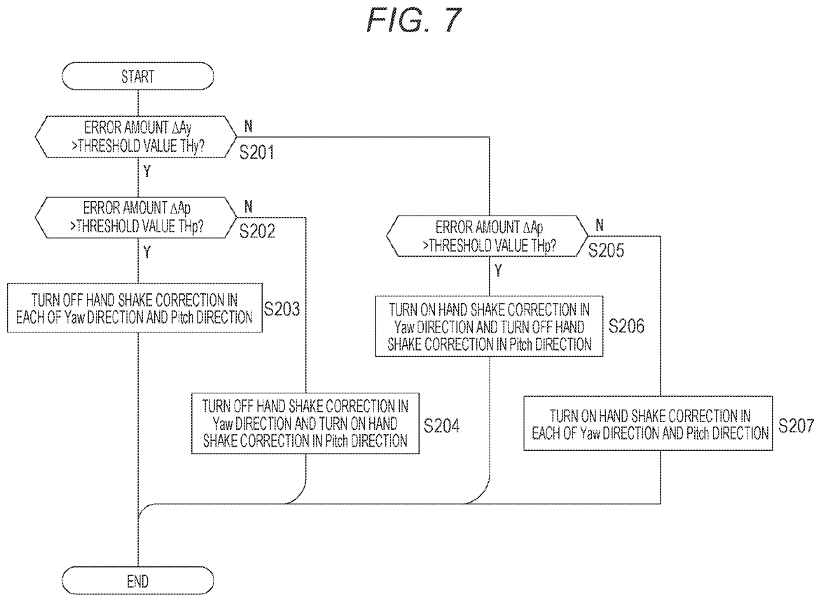

FIG. 7 is a flowchart illustrating a specific processing procedure to be executed by the control unit 16 to realize the hand shake correction control as the first embodiment as described above.

Note that the process illustrated in FIG. 7 is repeatedly executed for each frame of the captured image.

In FIG. 7, the control unit 16 determines whether or not the error amount ΔAy is greater than the threshold value THy in step S201, and if the error amount ΔAy is greater than the threshold value THy, the control unit 16 determines whether or not the error amount ΔAp is greater than the threshold value THp in step S202.

In a case where the error amount ΔAp is greater than the threshold value THp (that is, the movement control amounts in both the Yaw direction and the Pitch direction exceed the threshold values) in step S202, the processing proceeds to step S203, and the control unit 16 executes processing for turning off the hand shake correction in each of the Yaw direction and the Pitch direction. That is, the control unit 16 instructs the correction control unit 22 to turn off the hand shake correction in each of the Yaw direction (horizontal direction) and the Pitch direction (vertical direction).

On the other hand, in a case where the error amount ΔAp is not greater than the threshold value THp (that is, the movement control amount in only the Yaw direction exceeds the threshold value) in step S202, the processing proceeds to step S204, and the control unit 16 executes processing for turning off the hand shake correction in the Yaw direction and to turn on the hand shake correction in the Pitch direction.

Furthermore, in step S201, if the error amount ΔAy is not greater than the threshold value THy, the control unit 16 determines whether or not the error amount ΔAp is greater than the threshold value THp in step S205.

In a case where the error amount ΔAp is greater than the threshold value THp (that is, the movement control amount in only the Pitch direction exceeds the threshold value) in step S205, the processing proceeds to step S206, and the control unit 16 executes processing for turning on the hand shake correction in the Yaw direction and turning off the hand shake correction in the Pitch direction.

On the other hand, in a case where the error amount ΔAp is not greater than the threshold value THp (that is, the movement control amounts in both the Yaw direction and the Pitch direction are equal to or less than the threshold values) in step S205, the processing proceeds to step S207, and the control unit 16 executes processing for turning on the hand shake correction in each of the Yaw direction and the Pitch direction.

The process illustrated in FIG. 7 is terminated by executing the processing in step S203, S204, S206, or S207 by the control unit 16.

Note that in the process in FIG. 7, hysteresis can be added to the threshold values THy and THp to prevent chattering.

### 2. Second Embodiment

Subsequently, a second embodiment will be described.

In the second embodiment, the threshold value TH for the movement control amount is variable rather than fixed.

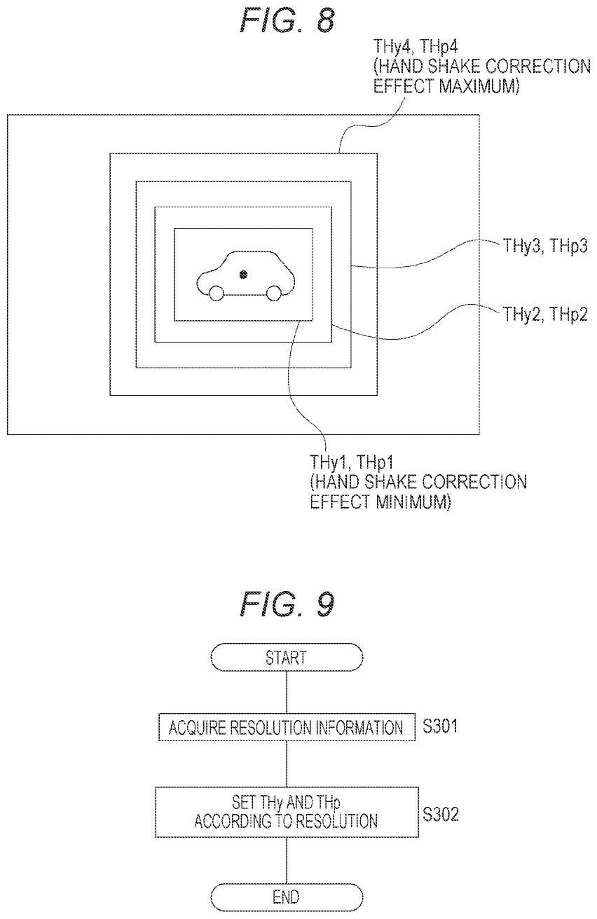

FIG. 8 is an explanatory view of an action by changing the threshold value TH.

First, a case where the threshold value TH is small is considered. As a value of the threshold value TH is small, the error amount ΔA is likely to exceed the threshold value TH even though an error amount ΔP of the position of the tracking target subject with respect to the target position in the captured image is small. That is, the smaller the threshold value TH, the less effective the hand shake correction is. Therefore, the hand shake correction effect is reduced. In FIG. 8, the smallest threshold value TH is represented as threshold values THy1 and THp1, but in a case where these threshold values THy1 and THp1 are set, the hand shake correction effect is minimized.

On the contrary, as the threshold value TH is large, the error amount ΔA is likely to exceed the threshold value TH even though the error amount ΔP of the position of the tracking target subject with respect to the target position is large. Thus, the hand shake correction is more effective. Accordingly, in a case where maximum threshold values THy4 and THp4 illustrated in FIG. 8 are set, the hand shake correction effect is maximized.

### 2-1. Control Example I

In Control Example I, the threshold value TH is set according to resolution.

In a case where the movement control amount for subject tracking is obtained on the basis of the position of the subject detected from the captured image, a low resolution of the captured image is a noise of the movement control amount. Therefore, the threshold value TH is set on the basis of the resolution, such that the hand shake correction effect is prevented from being turned off unnecessarily in response to the noise.

Specifically, the threshold value TH is dynamically changed to have a negative correlation with the resolution.

A flowchart of FIG. 9 illustrates a specific processing procedure to be executed by the control unit 16 to realize the hand shake correction control as Control Example I.

The control unit 16 acquires resolution information in step S301. That is, control unit 16 acquires information indicating resolution of the captured image obtained by the imager 11.

Then, in step S302, the threshold values THy and THp are set according to the resolution. Specifically, in the present example, a threshold value THy and a threshold value THp are set according to the number of pixels in the horizontal direction and the number of pixels in the vertical direction, respectively. At this time, the threshold value THy and the threshold value THp are set to be large as the number of pixels in the corresponding direction is small (as the resolution is low). That is, the threshold value TH is set to have a negative correlation with the resolution.

Note that in a case where the resolution is fixed in the imaging apparatus 10, it is not necessary to execute the process illustrated in FIG. 9, and it is only required to store the threshold value TH determined according to the resolution and perform the shake correction control using the threshold value TH.

Here, in Control Example I, the dynamic change of the threshold value TH may be a continuous change or a stepwise change. An example of the stepwise change of the threshold value TH can include a method in which in a case where an image quality is SD or lower, the threshold value TH is set to “high”, in a case where an image quality corresponds to HD, the threshold value TH is set to “medium”, and in a case where an image quality is 4K or higher, the threshold value TH is set to “low”, and the like. Furthermore, an example of the continuous change of the threshold value TH can include an example in which the threshold value TH is continuously changed in a specific partial range of the resolution (for example, SD image quality to 4K image quality) and the like.

### 2-2. Control Example II

In Control Example II, the threshold value TH is changed depending on an imaging target scene.

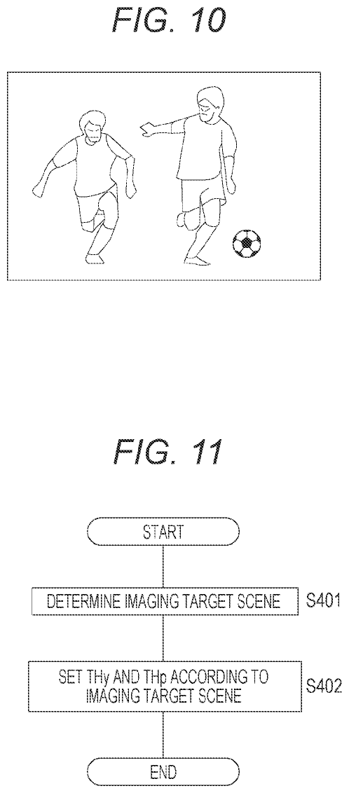

For example, in a ball game such as soccer or the like as illustrated in FIG. 10, it is expected that a tracking target subject which is a player moves at a relatively higher speed in an on-play state where the player is keeping a ball than in an off-play state. Since a movement angle becomes large at the moment when the tracking target subject moves at a high speed, in order to prevent deterioration of tracking response due to the hand shake correction acting in a direction opposite to a movement direction of the subject, it is effective to lower the threshold value TH to reduce the hand shake correction effect.

Specifically, in this case, whether or not the imaging target scene corresponds to at least one of a scene where the tracking target subject is in the on-play state or a scene where the tracking target subject is in the off-play state is determined by, for example, image analysis and the like, and in the case of the on-play state, the threshold value TH is set to be lower than that of the case of the off-play state. For example, the threshold value TH is minimized.

Alternatively, in a case where an imaging target is an athlete, since a player as a runner hardly moves at a starting point, the hand shake correction effect is preferably increased. However, it is effective to reduce the hand shake correction effect at the moment when the runner starts to run.

In this case, as the imaging target scene, whether or not the imaging target scene corresponds to at least one of a scene where the tracking target subject is stationary or a scene where the tracking target subject starts to run is determined by, for example, image analysis and the like, and in the case of the running scene, the threshold value TH is set to be lower (for example, minimized) than that of the case of the stationary scene.

Note that in a case where it is estimated that the tracking target subject starts to move and then transitions to motion at a uniform speed, the hand shake correction effect can be increased (for example, the threshold value TH returns to the original value).

Here, as a method of acquiring information on the imaging target scene required for determining the threshold value TH, a method of inputting information from the outside can also be adopted, in addition to the method using the image analysis described above.

In the acquisition of the information on the imaging target scene by the image analysis, for example, a general method such as machine learning (deep learning) or the like can be used. For example, it is possible to adopt a method of specifying the imaging target scene on the basis of behavior prediction of a subject by machine learning.

Furthermore, as the method of inputting the information from the outside, for example, it is conceivable that information on the imaging target scene obtained by the result of the image analysis by a camera other than the imaging apparatus 10 is input via the communication unit 19.

Note that the imaging target scene can be determined on the basis of the audio signal detected by the microphone 13. For example, in the example of the ball game such as soccer described above or the like, the imaging target scene can be determined on the basis of a whistle sound at the start of the play. Furthermore, in the example of the athletics, the imaging target scene can be determined on the basis of a pistol sound.

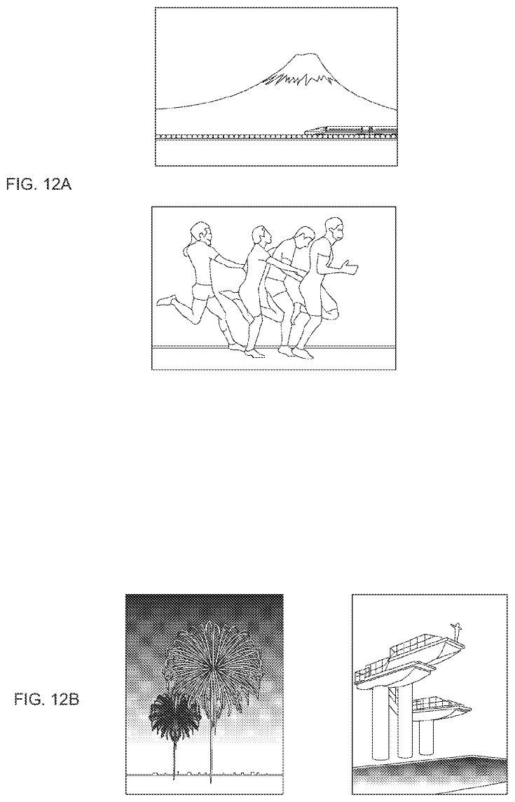

A flowchart of FIG. 11 illustrates a specific processing procedure to be executed by the control unit 16 to realize the hand shake correction control as Control Example II.

The control unit 16 determines an imaging target scene in step S401. That is, the imaging target scene is determined on the basis of the image analysis described above, audio analysis of the audio signal from the microphone 13, the information on the imaging target scene input from the outside, or the like.

Then, in following step S402, the control unit 16 sets a threshold value THy and a threshold value THp according to the imaging target scene. Specifically, the control unit 16 sets the threshold value THy and the threshold value THp corresponding to the imaging target scene determined in step S401.

Note that the threshold value TH for each imaging target scene can be changed on the basis of user operations.

### 2-3. Control Example III

In Control Example III, the hand shake correction is controlled on the basis of a movement direction of the subject.

FIG. 12 is a view illustrating a movement direction of the tracking target subject.

FIG. 12A is an example in which the tracking target subject moves in a lateral direction (horizontal direction). An upper side of FIG. 12A is an example in which the tracking target subject is a train, and a lower side of FIG. 12A is an example in which the tracking target subject is a runner. FIG. 12B is an example in which the tracking target subject moves in a longitudinal direction (vertical direction). A left side of FIG. 12B is an example in which the tracking target subject is fireworks, and a right side of FIG. 12B is an example in which the tracking target subject is a diver.

In the example of FIG. 12A, the platform apparatus 1 is moved in the Yaw direction to track the subject moving in the lateral direction, and thus, the tracking response in the Yaw direction is more likely to deteriorate, whereas the tracking response in the longitudinal direction (Pitch direction) is less likely to deteriorate. Therefore, it is desirable that the hand shake correction in the longitudinal direction works (acts) in terms of increasing image quality.

Similarly, in the example of FIG. 12B, the tracking response in the Pitch direction is more likely to deteriorate, whereas the tracking response in the Yaw direction is less likely to deteriorate. Therefore, it is desirable that the hand shake correction in the Yaw direction works (acts).

Therefore, in Control Example III, the movement direction of the tracking target subject is determined to make the hand shake correction effects different in a direction corresponding to the movement direction and a direction different from the direction. Specifically, if the movement direction is the horizontal direction, the threshold value THy in the Yaw direction is set to be lower than the threshold value THp in the Pitch direction. For example, the threshold value THy is minimized. Furthermore, if the movement direction is the vertical direction, the threshold value THp in the Pitch direction is set to be lower than the threshold value THy in the Yaw direction (for example, the threshold value THp is minimized).

Therefore, it is possible to reduce the hand shake correction effect in a direction in which the tracking response is more likely to deteriorate, and it is possible to increase the hand shake correction effect in a direction in which the tracking response is less likely to deteriorate, such that it is possible to prevent both the deterioration of the tracking response and image shake by the hand shake correction.

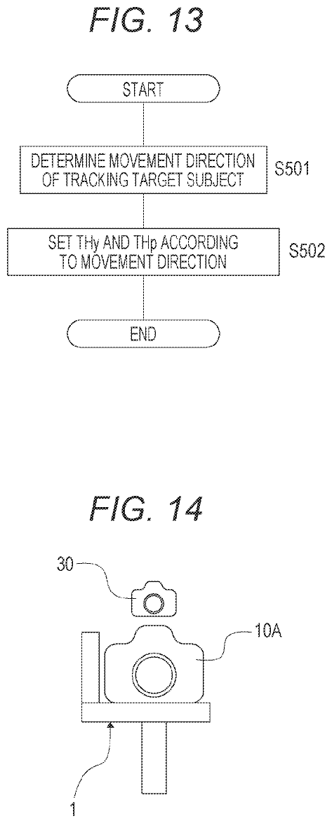

A flowchart of FIG. 13 illustrates a specific processing procedure to be executed by the control unit 16 to realize the hand shake correction control as Control Example III.

The control unit 16 performs movement direction determination processing of the tracking target subject in step S501. The movement direction determination processing is performed, for example, on the basis of a result of analyzing the captured image. In this case, the movement direction is not limited to a direction in which the tracking target subject actually moves, and a direction in which the movement is predicted can be used as the movement direction. The movement direction of the subject can be predicted by, for example, machine learning and the like.

Then, in following step S502, the control unit 16 sets a threshold value THy and a threshold value THp according to the movement direction. Specifically, the control unit 16 sets the threshold value THy and the threshold value THp corresponding to the movement direction determined in step S501. At this time, if the movement direction is the horizontal direction, the threshold values THy and THp correspond to each other so that the threshold value THp is greater than the threshold value THy (for example, the threshold value THy is the minimum value), and if the movement direction is the vertical direction, the threshold values THy and THp correspond to each other so that the threshold value THy is greater than the threshold value THp (for example, the threshold value THp is the minimum value).

Note that the example in which the threshold value TH is changed depending on the movement direction is exemplified in the above, but the hand shake correction in a direction corresponding to the movement direction can be turned off, and the hand shake correction in a direction different from the movement direction can be turned on. For example, if the movement direction is the horizontal direction, the hand shake correction in the Yaw direction is turned off, and the hand shake correction in the Pitch direction is turned on.

### 3. Modification

### 3-1. First Modification

Here, an imaging apparatus that obtains a captured image for obtaining a movement control amount and an imaging apparatus whose hand shake correction is controlled can be separate apparatuses.

FIG. 14 illustrates this example.

In this case, an imaging apparatus 30 corresponds to an imaging apparatus that obtains a captured image for obtaining a movement control amount, and an imaging apparatus 10A corresponds to an imaging apparatus whose hand shake correction is controlled. The imaging apparatus 30 and the imaging apparatus 10A are loaded on a common platform apparatus 1, the imaging apparatus 30 and the imaging apparatus 10A are moved in conjunction with each other in the Yaw direction and the Pitch direction according to driving of the platform apparatus 1 in the Yaw direction and the Pitch direction.

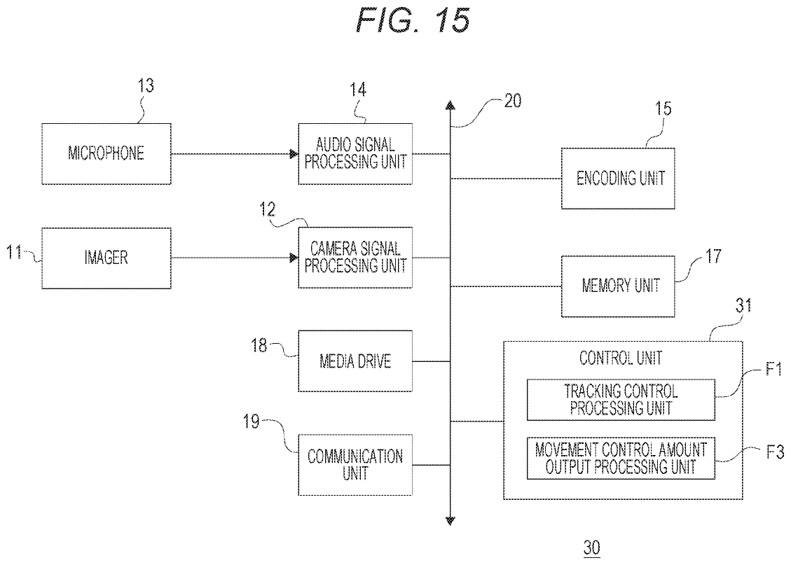

FIG. 15 is a block diagram illustrating an internal configuration example of the imaging apparatus 30. Note that in the following description, the same reference numerals are given to parts similar to the parts already described above and the description thereof will be omitted.

A difference from the imaging apparatus 10 illustrated in FIG. 3 is that a control unit 31 is provided instead of the control unit 16, and the shake correction actuator 21, the correction control unit 22, and the motion sensor 23 are omitted.

The control unit 31 has a function as the tracking control processing unit F1 described above, and similarly to the control unit 16, the control unit 31 performs a subject tracking control by calculating the error amounts ΔAy and ΔAp and outputting the error amounts ΔAy and ΔAp to the platform apparatus 1.

Furthermore, the control unit 31 has a function as a movement control amount output processing unit F3. By this function, the control unit 31 transmits information on movement control amounts as the error amounts ΔAy and ΔAp calculated by the tracking control processing unit F1 to the imaging apparatus 10A via the communication unit 19.

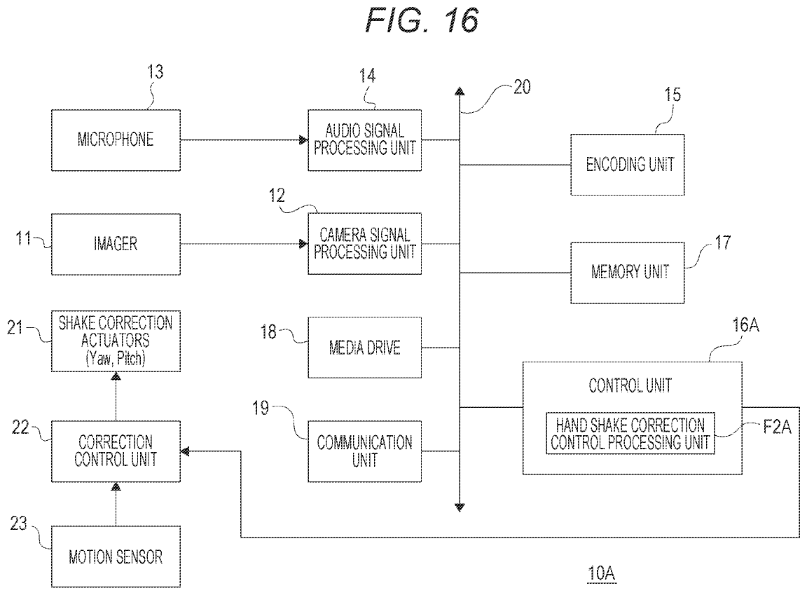

FIG. 16 is a block diagram illustrating an internal configuration example of the imaging apparatus 10A.

A difference from the imaging apparatus 10 is that a control unit 16A is provided instead of the control unit 16. The function as the tracking control processing unit F1 is omitted in the control unit 16A, and the control unit 16A has a function as a hand shake correction control processing unit F2A. By the function as the hand shake correction control processing unit F2A, the control unit 16A performs the hand shake correction control in similar methods described in the first and second embodiments on the basis of the information on the movement control amounts as the error amounts ΔAy and ΔAp transmitted by the imaging apparatus 30.

Here, in the imaging system having the configuration as described above, since parallax between the imaging apparatus 30 and the imaging apparatus 10A occurs, the error amounts ΔAy and ΔAp are calculated in consideration of the parallax. Specifically, the control unit 31 in the imaging apparatus 30 calculates the error amounts ΔAy and ΔAp according to an imaging viewpoint of the imaging apparatus 10A, for example, on the basis of preset parallax information.

Note that the imaging apparatus 30, that is, the imaging apparatus that obtains the captured image for obtaining the movement control amount executes processing up to obtaining of the movement control amount on the basis of its own captured image and outputting of the movement control amount to the imaging apparatus 10A, but it is possible to adopt a configuration in which the imaging apparatus 30 (control unit 31) outputs the position of the tracking target subject to the imaging apparatus 10A by performing processing up to obtaining of the position of the tracking target subject from the captured image, and the imaging apparatus 10A (control unit 16A) calculates the movement control amount on the basis of the position of the tracking target subject, and outputs the movement control amount to the platform apparatus 1. Note that in this case, the control unit 16A obtains the movement control amount on the basis of the parallax information to make the position of the tracking target subject a position of the imaging viewpoint of the imaging apparatus 10A.

Alternatively, the imaging apparatus 30 can be configured to be executed up to the hand shake correction control based on the movement control amount. Specifically, the control unit 31 is configured to perform ON/OFF determination of the hand shake correction on the basis of the error amount ΔA and the threshold value TH, and to instruct the imaging apparatus 10A to turn on or off the hand shake correction according to the result of the determination.

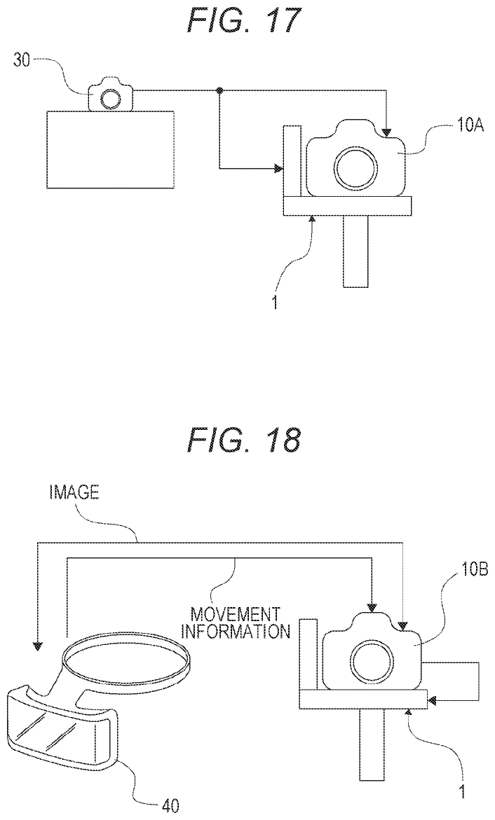

Note that as the example in which the imaging apparatus that obtains the captured image for obtaining the movement control amount and the imaging apparatus whose hand shake correction is controlled are separate apparatuses, the imaging apparatus 30 which is not mounted on the platform apparatus 1 (not connected to the imaging apparatus 10A) as illustrated in FIG. 17 can also be exemplified.

In this case, in the imaging apparatus 30, external parameters of the camera is calculated by calibrating the position relationship with the imaging apparatus 10A in advance, and the error amount ΔA is calculated on the basis of the external parameters. At this time, the external parameters can be calculated by, for example, a method using a general checkerboard or the like.

### 3-2. Second Modification

In a second modification, it is premised on an imaging system using a head-mounted display (HMD).

FIG. 18 is a view for explaining a configuration example of the imaging system as the second modification.

The imaging system in the case illustrated in FIG. 18 includes an HMD 40, an imaging apparatus 10B, and a platform apparatus 1. As illustrated in FIG. 18, the imaging apparatus 10B is mounted on the platform apparatus 1 in a similar manner as in the imaging apparatus 10.

The HMD 40 is mounted on a head of a user and displays an image captured by the imaging apparatus 10B. Furthermore, the HMD 40 detects a movement of the head of the user and outputs information on the detected movement to the imaging apparatus 10B.

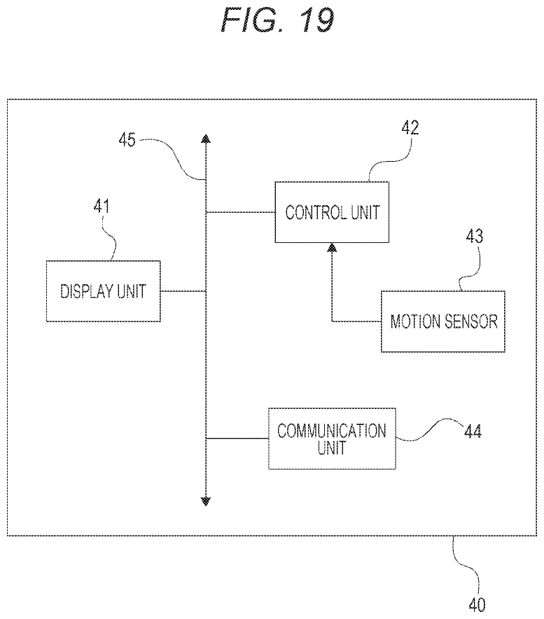

FIG. 19 is a block diagram illustrating an internal configuration example of the HMD 40.

A display unit 41 is a means for displaying the captured image for the user, and is connected to a communication unit 44 and a control unit 42 via a bus 45.

The control unit 42 includes, for example, a microcomputer, and controls the entire HMD 40. A motion sensor 43 is connected to the control unit 42, and the movement information on the head of the user can be acquired. The motion sensor 43 is, for example, an angular velocity sensor, and a biaxial angular velocity sensor that detects a movement in the rotation direction of each of the Yaw direction and the Pitch direction is used in the present example.

The control unit 42 transmits information on the movement (angular velocity information in each of the Yaw direction and the Pitch direction in the present example) detected by the motion sensor 43 to the imaging apparatus 10B via the communication unit 44.

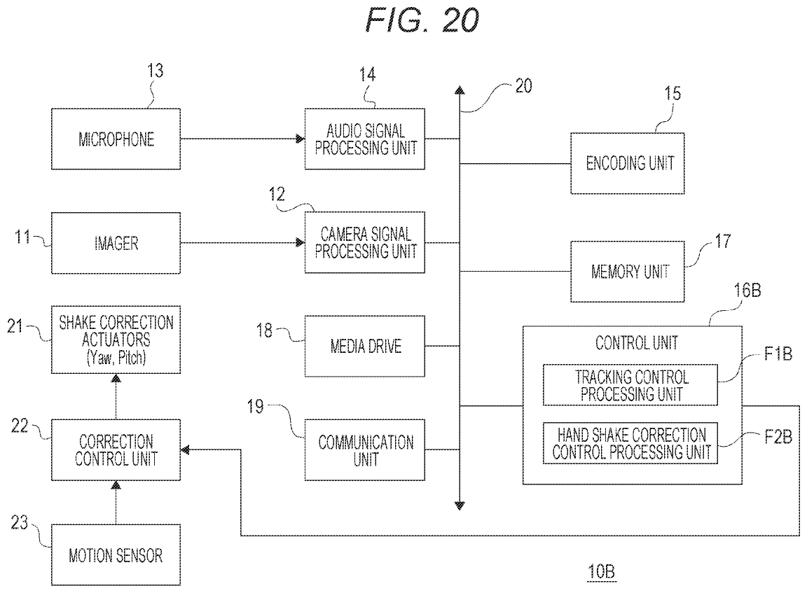

FIG. 20 is a block diagram illustrating an internal configuration example of the imaging apparatus 10B.

A difference from the imaging apparatus 10 is that a control unit 16B is provided instead of the control unit 16. The control unit 16B is different from the control unit 16 in that a tracking control processing unit F1B is provided instead of the tracking control processing unit F1, and a hand shake correction control processing unit F2B is provided instead of the hand shake correction control processing unit F2.

The tracking control processing unit F1B basically executes subject tracking by outputting the error amounts ΔAy and ΔAp to the platform apparatus 1 in a similar manner as in the tracking control processing unit F1. However, the tracking control processing unit F1B determines whether or not switching of the tracking target subject is instructed by the user wearing the HMD 40 due to the movement of the head of the user (the movement of the HMD 40) on the basis of the movement information transmitted from the HMD 40. In a case where it is determined that switching is instructed, tracking control is turned off, and the platform apparatus 1 is rotated in a movement direction of the HMD 40 (that is, a movement direction of the head). Then, another subject (a subject other than the subject which is the tracking target) existing in the movement direction of the HMD 40 is positioned in the vicinity of the target position in the image, and accordingly, tracking control is restarted with the other subject as a tracking target subject.

Here, when the tracking control is turned off and the platform apparatus 1 is rotated according to the movement direction of the HMD 40 as described above, the switching of the tracking target subject cannot be smoothly performed in a state where the hand shake correction is turned on. Therefore, in the present example, when the tracking control is turned off on the basis of the movement information of the HMD 40 as described above, the threshold value TH is decreased to reduce the hand shake correction effect (for example, minimized). Then, thereafter, when the tracking control with the other subject as the tracking target subject is restarted, the threshold value TH is increased to increase the hand shake correction effect.

The hand shake correction control processing unit F2B performs processing for changing the corresponding threshold value TH at the time of switching such a tracking target subject.

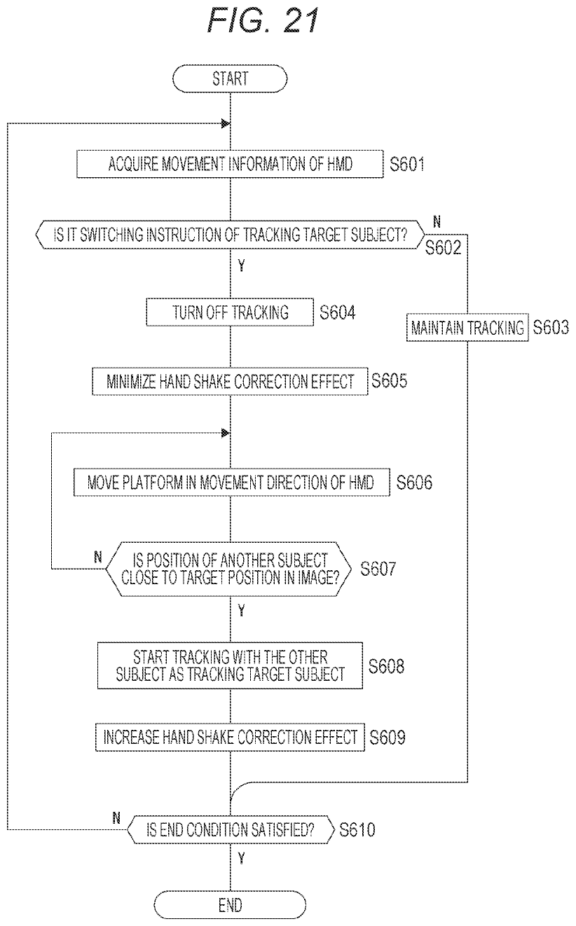

A flowchart of FIG. 21 illustrates a specific processing procedure to be executed by the control unit 16B to realize the operation as the second modification described above.

First, the control unit 16B acquires information on a movement of the HMD in step S601, and determines whether or not it is an instruction to switch the tracking target subject in following step S602. In step S602, for example, it is determined whether or not a value of an angular velocity acquired as the movement information exceeds a predetermined threshold value (at least one of the Yaw direction or the Pitch direction). Alternatively, it is determined whether or not a difference between an angle change amount of the HMD 40 obtained from the information on the angular velocity and the error amount ΔA exceeds a predetermined threshold value (at least one of the Yaw direction or the Pitch direction).

Here, if another subject does not exist in the movement direction of the HMD 40 indicated by the movement information, switching of the tracking target subject is not instructed. Therefore, the control unit 16B determines whether or not another subject exists in the movement direction by image analysis, and a result thereof can be reflected to the determination in step S602.

In step S602, in a case where it is determined that it is not an instruction to switch the tracking target subject, the processing proceeds to step S603, and the control unit 16B maintains the tracking, that is, the processing proceeds to step S610 without turning off the tracking.

On the other hand, in step S602, in a case where it is determined that it is an instruction to switch the tracking target subject, the processing proceeds to step S604, and the control unit 16B turns off the tracking, and in following step S605, the control unit 16B performs processing for minimizing the hand shake correction effect. That is, the threshold value TH is minimized. Here, the processing in step S605 is performed as processing for minimizing the threshold value TH in a direction according to the movement direction of the HMD 40. For example, if the movement direction of the HMD 40 is the Yaw direction, the threshold value THy in the Yaw direction is minimized. Alternatively, if the movement of the HMD 40 is large in both the Yaw direction and the Pitch direction (that is, when the HMD 40 largely moves in a diagonal direction), it is conceivable that both the threshold value THy and the threshold value THp are minimized.

In step S606 following step S605, the control unit 16B executes processing for moving the platform apparatus 1 in the movement direction of the HMD 40. Next, in step S607, it is determined whether or not a position of another subject is close to the target position in the image. For example, it is determined whether or not an error between the position of the other subject and the target position (pixel number unit) is equal to or less than a predetermined threshold value.

If the position of the other subject is not close to the target position, the control unit 16 returns to step S606. Therefore, the platform apparatus 1 is driven in the movement direction of the HMD 40 until the position of the other subject is close to the target position.

On the other hand, in a case where the position of the other subject is close to the target position, the control unit 16B starts to track the other subject as the tracking target subject in step S608, and executes processing for increasing the hand shake correction effect in step S609, that is, executes processing for increasing the threshold value TH minimized in step S605, and the processing proceeds to step S610.

In step S610, the control unit 16B determines whether or not a preset termination condition, for example, a predetermined termination condition such as recording termination of the captured image or turning off of the power, or the like is satisfied, if the termination condition is not satisfied, the processing returns to step S601, and if the termination condition is satisfied, the process illustrated in FIG. 21 is terminated.

### 3-3. Other Modifications

Here, the embodiments are not limited to the specific examples described above, and various modifications can be adopted.

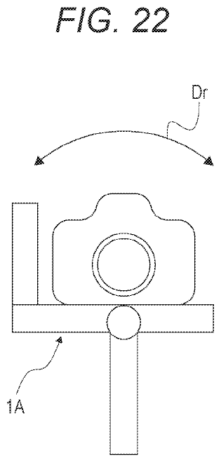

For example, both directions of the Yaw direction and the Pitch direction are exemplified as the movement direction for the subject tracking in the above, but the movement direction may include a roll direction. FIG. 22 illustrates a platform apparatus 1A that can be driven in a roll direction (direction indicated by an arrow Dr in FIG. 22).

Furthermore, the movement direction for the subject tracking is not limited to two directions, and can be three directions or more or only one direction.

Furthermore, the movement direction is not limited to the rotation direction, and can be a translation direction. That is, the movement control amount of the imaging apparatus (imaging apparatus whose hand shake correction is controlled) can include not only the movement control amount in the imaging direction but also the movement control amount of the imaging viewpoint.

Furthermore, the optical hand shake correction is exemplified as the hand shake correction in the above, but electrical hand shake correction as disclosed in Patent Document 1 described above can be applied as the hand shake correction, for example.

Note that in a case where the optical hand shake correction is adopted, a hand shake correction means may be included in both a lens and a body in some cases. In a case where both functions of these hand shake correction means are validated, both are used as a hand shake correction control target as an embodiment. Alternatively, in a case where only one of the hand shake correction means in the lens or in the body is validated, one of the hand shake correction means to be validated is used as a target, and the hand shake correction control is performed as an embodiment.

Furthermore, when a plurality of hand shake correction means exists, directions of shake correction may be shared in some cases. For example, a case where the hand shake correction means in the body is in charge of the hand shake correction in the Yaw direction and the Pitch direction and the hand shake correction means in the lens is in charge of the hand shake correction in the roll direction can be exemplified. Alternatively, a configuration in which the hand shake correction means in the body is in charge of the hand shake correction in the translation direction as the horizontal direction and the vertical direction and the hand shake correction means in the lens is in charge of the hand shake correction in the roll direction is also considered, for example.

### 4. Summary of Embodiments

The imaging control apparatuses (imaging apparatuses 10, 10A, and 10B) as the embodiments described above include the control units (control units 16, 16A, and 16B) that control the hand shake correction of the imaging apparatuses on the basis of the obtained movement control amounts of the imaging apparatuses to make the position of the subject the predetermined position in the captured image.

With this arrangement, the hand shake correction control is performed on the basis of a movement amount of the imaging apparatus to track the subject.

Accordingly, in the subject tracking control in a case where the imaging apparatus having the hand shake correction function is used, it is possible to prevent the deterioration of the tracking response.

Furthermore, in the imaging control apparatus as the embodiment, the control unit controls the hand shake correction on the basis of the result of comparing the movement control amount with the threshold value.

With this arrangement, the hand shake correction can be controlled so that the hand shake correction is maintained in a turned-on state in a case where the movement amount of the imaging apparatus is equal to or less than a predetermined amount and the hand shake correction is turned off in a case where the movement amount is larger than the predetermined amount.

Accordingly, it is possible to turn off the hand shake correction only in a case where the hand shake correction is likely to act in a direction opposite to the subject tracking direction, such that it is possible to prevent both the deterioration of the tracking response and the image shake by the hand shake correction.

Moreover, in the imaging control apparatus as the embodiment, the control unit dynamically changes the threshold value (for example, see Control Example II and Control Example III).

With this arrangement, the hand shake correction effect can be adaptively changed depending on a predetermined condition.

Accordingly, the hand shake correction effect can be appropriately controlled according to the condition, such that it is possible to prevent both the deterioration of the tracking response and the image shake by the hand shake correction.

Furthermore, in the imaging control apparatus as the embodiment, the control unit controls the hand shake correction on the basis of the resolution of the captured image for obtaining the movement control amount (see, Control Example I).

In a case where the movement control amount for tracking is obtained on the basis of a position of the subject detected from the captured image, a low resolution of the captured image is a noise of the movement control amount. Therefore, the hand shake correction is controlled on the basis of the resolution, such that the hand shake correction effect is prevented from being turned off unnecessarily in response to the noise.

Accordingly, it is possible to prevent both the deterioration of the tracking response and the image shake by the hand shake correction.

Furthermore, in the imaging control apparatus as the embodiment, the control unit controls the hand shake correction on the basis of the result of comparing the movement control amount with the threshold value, and sets the threshold value to have a negative correlation with the resolution.

With this arrangement, the hand shake correction is prevented from being turned off unnecessarily in response to the noise.

Accordingly, it is possible to prevent both the deterioration of the tracking response and the image shake by the hand shake correction.

Moreover, in the imaging control apparatus as the embodiment, the control unit changes the threshold value according to the imaging target scene (see, Control Example II).

With this arrangement, the hand shake correction effect can be changed depending on a change of the imaging target scene such as a scene where a subject does not move while being stationary, a scene where a stationary subject starts to quickly move, or the like.

Accordingly, it is possible to perform the hand shake correction control such as reducing of the hand shake correction effect in a scene where the tracking response is more likely to deteriorate, increasing of the hand shake correction effect in a scene where the tracking response is less likely to deteriorate, and the like, such that it is possible to prevent both the deterioration of the tracking response and the image shake by the hand shake correction.

Furthermore, in the imaging control apparatus as the embodiment, the control unit controls the hand shake correction on the basis of the movement direction of the subject (see Control Example III).

With this arrangement, it is possible to reduce the hand shake correction effect for shake occurring in the movement direction of the subject and to increase the hand shake correction effect for shake occurring in a direction different from the movement direction of the subject.

Therefore, it is possible to reduce the hand shake correction effect in a direction in which the tracking response is more likely to deteriorate, and it is possible to increase the hand shake correction effect in a direction in which the tracking response is less likely to deteriorate, such that it is possible to prevent both the deterioration of the tracking response and the image shake by the hand shake correction.

Furthermore, in the imaging control apparatus as the embodiment, the control unit makes hand shake correction effects different in a direction corresponding to the movement direction and a direction different from the direction.

With this arrangement, it is possible to reduce the hand shake correction effect in a direction in which tracking response is more likely to deteriorate, and it is possible to increase the hand shake correction effect in a direction in which the tracking response is less likely to deteriorate.

Accordingly, it is possible to prevent both the deterioration of the tracking response and the image shake by the hand shake correction.

Moreover, in the imaging control apparatus as the embodiment, the control unit obtains the movement control amount on the basis of the information on the position of the subject detected from the captured image.

With this arrangement, in the obtaining of the movement control amount, the position information on the subject can be detected from the captured image.

Accordingly, it is not required to provide a separate sensor other than the image sensor to detect the information of the position of the subject, such that an apparatus configuration can be simplified and cost save can be achieved.

Furthermore, in the imaging control apparatus as the embodiment, the control unit obtains the movement control amount on the basis of the attention position of the subject detected from the captured image.

With this arrangement, tracking control can be performed by making a portion to be paid attention of the subject a predetermined position such as the central position or the like in the captured image.

Accordingly, it is possible to prevent a portion of the subject to be paid attention from being cut off from the captured image.

Furthermore, in the imaging control apparatus as the embodiment, the imaging apparatus (imaging apparatus 30) that captures the captured image for obtaining the movement control amount and the imaging apparatus (imaging apparatus 10A) in which the hand shake correction is controlled by the control unit are separate apparatuses (see the first modification).

With this arrangement, the imaging apparatus whose hand shake correction is controlled is not required to execute processing for obtaining the movement control amount on the basis of its own captured image.

Accordingly, it is possible to reduce a processing load of the imaging apparatus whose hand shake correction is controlled.

Moreover, in the imaging control apparatus as the embodiment, the control unit (control unit 16A) controls the hand shake correction on the basis of the movement control amount obtained on the basis of the parallax information between the two imaging apparatuses.

Therefore, it is possible to realize accurate subject tracking while reducing the processing load of the imaging apparatus whose hand shake correction is controlled.

Furthermore, in the imaging control apparatus as the embodiment, the control unit controls the hand shake correction on the basis of the movement information on the head-mounted display.

Therefore, in a case where a movement of the head-mounted display corresponds to an instruction to switch the tracking target subject by a user, the hand shake correction acts, and thus, it is possible to prevent tracking of a new subject from being inhibited.

Furthermore, an imaging control method as an embodiment is an imaging control method, the method including controlling hand shake correction of an imaging apparatus on the basis of an obtained movement control amount of the imaging apparatus to make a position of a subject a predetermined position in a captured image.

A similar action and effect to those of the imaging control apparatus as the embodiment described above can be obtained also by such an imaging control method as the embodiment.

A program of an embodiment is a program for causing an information processing device to realize a function of controlling hand shake correction of an imaging apparatus on the basis of an obtained movement control amount of the imaging apparatus to make a position of a subject a predetermined position in a captured image.

That is, the program of the embodiment is the program for causing the information processing device to realize processing illustrated in FIGS. 7, 11, 13, and 21, and the like.

Such a program facilitates the realization of the imaging control apparatus as the embodiment.

Then, such a program can be recorded in a recording medium built in a device such as a computer device or the like, ROM in a microcomputer having a CPU, or the like, in advance. Alternatively, the program can be stored (recorded) temporarily or permanently in a removable recording medium such as a semiconductor memory, a memory card, an optical disk, a magneto-optical disk, a magnetic disk, or the like. Furthermore, such a removable recording medium can be provided as so-called package software.

Furthermore, such a program can be installed in a personal computer or the like from the removable recording medium, and can be downloaded from a download site via a network such as a local area network (LAN), Internet, or the like.

Note that the effects described in the present specification are merely exemplary and not limited and other effects may be obtained.

### 5. Present Technology

Note that the present technology can adopt the following configurations.

(1)

An imaging control apparatus including

a control unit that controls hand shake correction of an imaging apparatus on the basis of an obtained movement control amount of the imaging apparatus to make a position of a subject a predetermined position in a captured image.

(2)

The imaging control apparatus according to (1), in which

the control unit controls the hand shake correction on the basis of a result of comparing the movement control amount with a threshold value.

(3)

The imaging control apparatus according to (2), in which

the control unit dynamically changes the threshold value.

(4)

The imaging control apparatus according to any one of (1) to (3), in which

the control unit controls the hand shake correction on the basis of a resolution of the captured image for obtaining the movement control amount.

(5)

The imaging control apparatus according to (4), in which

the control unit

controls the hand shake correction on the basis of a result of comparing the movement control amount with a threshold value, and

sets the threshold value to have a negative correlation with the resolution.

(6)

The imaging control apparatus according to any one of (3) to (5), in which

the control unit changes the threshold value depending on an imaging target scene.

(7)

The imaging control apparatus according to any one of (1) to (6), in which

the control unit controls the hand shake correction on the basis of a movement direction of the subject.

(8)

The imaging control apparatus according to (7), in which

the control unit makes hand shake correction effects different in a direction corresponding to the movement direction and a direction different from the direction.

(9)

The imaging control apparatus according to any one of (1) to (8), in which

the control unit obtains the movement control amount on the basis of information on the position of the subject detected from the captured image.

(10)

The imaging control apparatus according to (9), in which

the control unit obtains the movement control amount on the basis of an attention position of the subject detected from the captured image.

(11)

The imaging control apparatus according to any one of (1) to (10), in which

the imaging apparatus that captures the captured image for obtaining the movement control amount and the imaging apparatus whose hand shake correction is controlled by the control unit are separate apparatuses.

(12)

The imaging control apparatus according to (11), in which

the control unit controls the hand shake correction on the basis of the movement control amount obtained on the basis of parallax information between the two imaging apparatuses.

(13)

The imaging control apparatus according to any one of (1) to (13), in which

the control unit controls the hand shake correction on the basis of movement information on a head-mounted display.

### REFERENCE SIGNS LIST

1 Platform apparatus
2 Rotation shaft portion
3 Rotation shaft portion
4 Base portion
5 Mounting portion
5a Joint mechanism
6 Arm portion
10, 10A, 10B Imaging apparatus
16, 16A, 16B Control unit
21 Shake correction actuator
22 Correction control unit
23 Motion sensor
F1, F1B Tracking control processing unit
F2A, F2B Hand shake correction control processing unit
F3 Movement control amount output processing unit
30 Imaging apparatus
40 Head-mounted display (HMD)

1. An imaging control apparatus comprising
a control unit that controls hand shake correction of an imaging apparatus on a basis of an obtained movement control amount of the imaging apparatus to make a position of a subject a predetermined position in a captured image.

2. The imaging control apparatus according to claim 1, wherein
the control unit controls the hand shake correction on a basis of a result of comparing the movement control amount with a threshold value.

3. The imaging control apparatus according to claim 2, wherein
the control unit dynamically changes the threshold value.

4. The imaging control apparatus according to claim 1, wherein
the control unit controls the hand shake correction on a basis of a resolution of the captured image for obtaining the movement control amount.

5. The imaging control apparatus according to claim 4, wherein
the control unit
controls the hand shake correction on a basis of a result of comparing the movement control amount with a threshold value, and
sets the threshold value to have a negative correlation with the resolution.

6. The imaging control apparatus according to claim 3, wherein
the control unit changes the threshold value depending on an imaging target scene.

7. The imaging control apparatus according to claim 1, wherein
the control unit controls the hand shake correction on a basis of a movement direction of the subject.

8. The imaging control apparatus according to claim 7, wherein
the control unit makes hand shake correction effects different in a direction corresponding to the movement direction and a direction different from the direction.

9. The imaging control apparatus according to claim 1, wherein
the control unit obtains the movement control amount on a basis of information on the position of the subject detected from the captured image.

10. The imaging control apparatus according to claim 9, wherein
the control unit obtains the movement control amount on a basis of an attention position of the subject detected from the captured image.

11. The imaging control apparatus according to claim 1, wherein
the imaging apparatus that captures the captured image for obtaining the movement control amount and the imaging apparatus whose hand shake correction is controlled by the control unit are separate apparatuses.

12. The imaging control apparatus according to claim 11, wherein
the control unit controls the hand shake correction on the basis of the movement control amount obtained on a basis of parallax information between the two imaging apparatuses.

13. The imaging control apparatus according to claim 1, wherein
the control unit controls the hand shake correction on a basis of movement information on a head-mounted display.

14. An imaging control method comprising
controlling hand shake correction of an imaging apparatus on a basis of an obtained movement control amount of the imaging apparatus to make a position of a subject a predetermined position in a captured image.

15. A program for causing an information processing device to realize a function of controlling hand shake correction of an imaging apparatus on a basis of an obtained movement control amount of the imaging apparatus to make a position of a subject a predetermined position in a captured image.
